(19) United States
(12) Patent Application Publication
(10) Pub. No.: US 2016/0374880 A1
(43) Pub. Date: Dec. 29, 2016

(54) Adjustable Bedframe for Existing Bedframe Structures

(71) Applicant: Damon Fisher, Baldwyn, MS (US)

(72) Inventor: Damon Fisher, Baldwyn, MS (US)

(73) Assignee: Limoss US, LLC

(21) Appl. No.: 14/751,729

(22) Filed: Jun. 26, 2015

(51) Int. Cl. A61G 7/015; A61G 7/018

(52) U.S. Cl. CPC A61G 7/015; A61G 7/018

(57) ABSTRACT

An adjustable bedframe that is placed onto the structure of an existing bedframe so as to maintain the familiar environment for the user of the adjustable bedframe while providing the convenience and benefits of an adjustable bed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

Field of the Invention

The present disclosure reveals an adjustable bedframe that can be placed onto an existing bedframe structure. The intent of this disclosure is to maintain as much of the original environment as possible for the user of the adjustable bedframe while allowing the functionality and benefits provided by the adjustable bedframe.

Background of the Invention

Adjustable bedframes are used in hospitals, nursing facilities and homes to aid persons with disabilities in comfort and care. The existing state of the art of adjustable bedframes are large pieces of automated furniture that are impersonal and in the home care environment requires the existing bed structure the disabled person has used for years to be removed from his or her bedroom. The present disclosure allows the disabled person to keep his or her familiar bedframe structure by removing the existing box frame and mattress, placing the present disclosure onto the bedframe structure with a mattress and thus preserving the environment with which the disabled person is familiar.

Multiple patents and patent applications have been filed related to adjustable bedframes but the present disclosure is distinguishable as follows:

In U.S. Pat. No. 3,739,409, Adjustable Mattress, Jun. 19, 1973, Johnson reveals an adjustment mechanism for an adjustable mattress wherein the adjustment mechanism is within the mattress, whereas the present disclosure is for an adjustable frame that fits on an existing bedframe structure and the mattress placed onto the adjustable bedframe.

In U.S. Pat. No. 8,863,332, Articulating Mattress with Embedded Deck, Oct. 21, 2014, Rohr reveals an adjustment mechanism for an adjustable mattress wherein the adjustment mechanism is within the mattress, whereas the present disclosure is for an adjustable frame that fits an existing bedframe structure and the mattress placed onto the adjustable bedframe.

In U.S. Pat. No. 3,952,346, Collapsible Elevating Board for Bed Mattresses, Apr. 27, 1976, Carlson reveals a pair of boards hinged together at one end, with multiple levels which the opposite end of the boards can be separated, so as to adjust one end of a mattress on an incline, whereas the present disclosure is for an adjustable frame that fits on an existing bedframe structure and the mattress placed onto the adjustable bedframe.

In U.S. Pat. No. 4,095,296, Adjustable Bed, Jun. 20, 1978, Ferro reveals an adjustment bed and bedframe combination, whereas the present disclosure is for an adjustable frame that fits on an existing bedframe structure and the mattress placed onto the adjustable bedframe.

In U.S. Pat. No. 6,684,427, Hospital Bed and Mattress having a Retractable Foot Section, Feb. 3, 2004, Allen et al., reveals a automated hospital bed with retractable foot section, whereas the present disclosure is for an adjustable frame that fits on an existing bedframe structure and the mattress placed onto the adjustable bedframe.

In U.S. Pat. No. 7,000,269, Adjustable Base for Supporting Adjustable Beds of Different Widths, Feb. 21, 2006, Borda reveals an adjustable bedframe base and mattress adjustment mechanism, whereas the present disclosure is for an adjustable frame that fits on an existing bedframe structure and the mattress placed onto the adjustable bedframe.

In U.S. Pat. App. No. 2007/0163048, Articulated Bed, Jul. 19, 2007, Eriksson et al., reveals an articulated mattress support with a power assembly built into the bedframe, whereas the present disclosure is for an adjustable frame that fits on an existing bedframe structure and the mattress placed onto the adjustable bedframe.

In U.S. Pat. No. 7,454,805, Hospital Bed, Nov. 25, 2008, Osborne et al., reveals a hospital bed with multiple features, whereas the present disclosure is for an adjustable frame that fits on an existing bedframe structure and the mattress placed onto the adjustable bedframe.

In U.S. Pat. No. 7,644,455, Adjustable Bed Frame, Jan. 12, 2010, Chang reveals an adjustable bedframe where portions of the frame around the edges can be elevated or lowered to prevent an infant from rolling out of the bed, as well as the ability to adjust the elevation of the mattress for the convenience of the height of the user, whereas the present disclosure is for an adjustable frame that fits on the existing bedframe structure.

In U.S. Pat. No. 7,926,131, Hospital Bed, Apr. 19, 2011, Menkedick reveals a hospital bed with multiple features, whereas the present disclosure is for an adjustable frame that fits on the existing bedframe structure.

In U.S. Pat. No. 8,151,387, Hospital Bed Frame, Apr. 10, 2012, Osborne et al., reveals a hospital bed with multiple features, whereas the present disclosure is for an adjustable frame that fits on the existing bedframe structure.

In Patent No. EP 1,525,824, Mechanism for Articulated Mattress Support, Published Apr. 27, 2005, Nito et al., reveals an adjustable bed, whereas the present disclosure is for an adjustable frame that fits on the existing frame of a bed.

In Patent No. EP 1,525,824, Fully Adjustable Bedframe, Nov. 25, 2009, Schmidt reveals an adjustment mechanism for an adjustable mattress wherein the adjustment mechanism is within the mattress, whereas the present disclosure is for an adjustable frame for mattress that fits on the existing bedframe structure and a mattress is placed onto the disclosure.

In Pat. App. No. WO 2004100723, Articulated Bed, Nov. 25, 2004, Eriksson et al., reveals an articulated mattress support with a power assembly built into the bedframe, whereas the present disclosure is for an adjustable frame that fits on the existing bedframe structure.

### SUMMARY OF THE INVENTION

An adjustable bedframe that is placed onto the structure of an existing bedframe so as to maintain the familiar environment for the user of the adjustable bedframe while providing the convenience and benefits of an adjustable bed. The upper adjustment means and the lower adjustment means can be operated either manually, with the use of a crank means or electronically, wherein the upper adjustment means and lower adjustment means are motorized and have an electronic control means.

### BRIEF DESCRIPTION OF THE SEVERAL VIEWS OF THE DRAWING

FIG. 1 is a view of the adjustable bedframe on an existing bedframe structure with mattress on top;

FIG. 2 is a view of the adjustable bedframe including base, adjustable frame, upper adjustment means, and lower adjustment means;

FIG. 3 is a view of the base

FIG. 4 is a view of the adjustable frame including the head portion, center portion, lower portion, and foot portion;

FIG. 5 is a view of the head portion, center portion, lower portion, and foot portion of the adjustable frame relative to the base;

FIG. 6A is a view of the first embodiment of the controller indicating the crank means associated with the upper adjustment means and the crank means associated lower adjustment means;

FIG. 6B is a view of the second embodiment of the controller including the electronic means associated with the upper adjustment means and the electronic means for the lower adjustment means; and

FIG. 6C is a view of the second embodiment of the controller wherein a single controller is an electronic means that operates the upper adjustment means and the lower adjustment means.

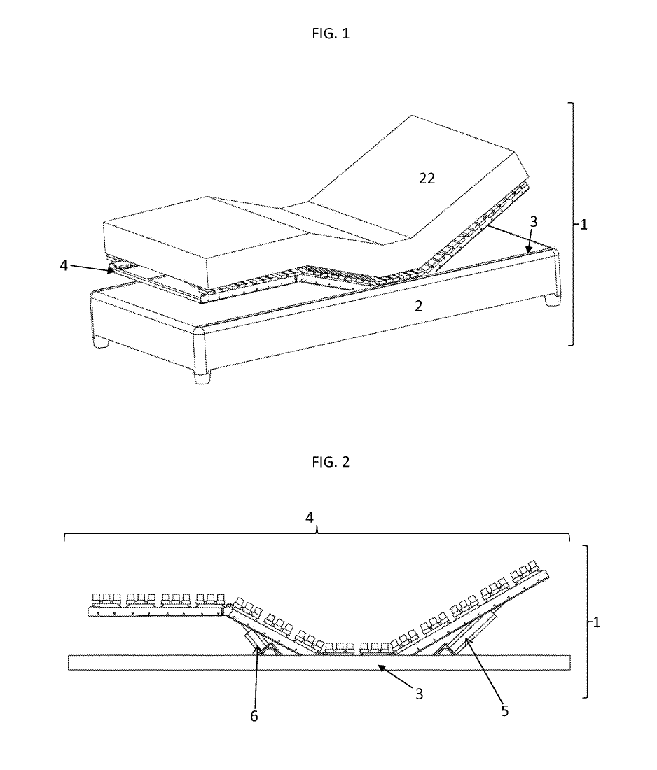

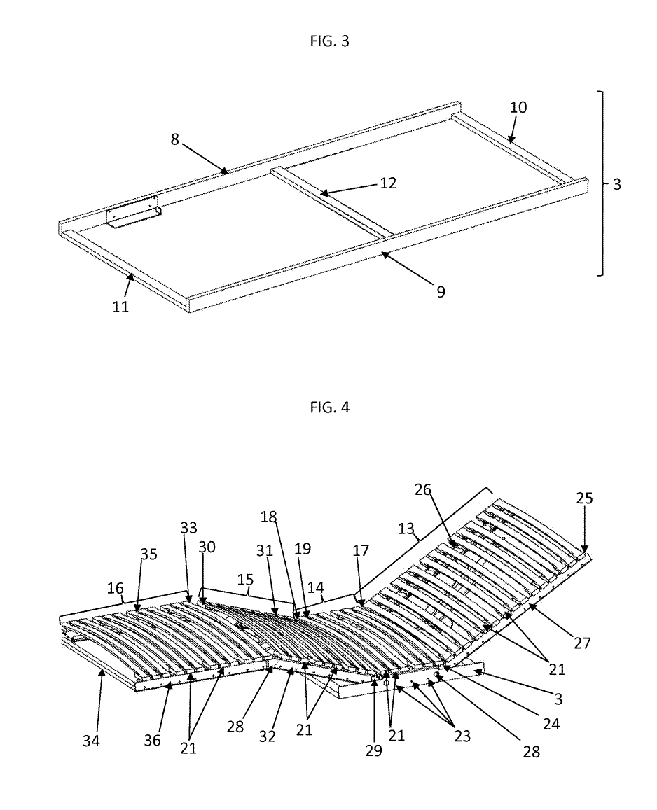

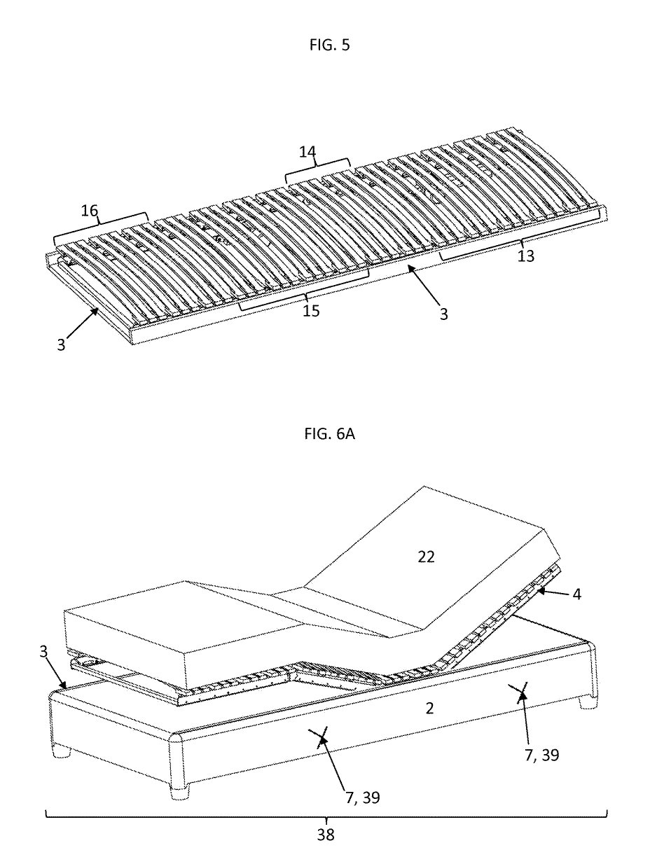

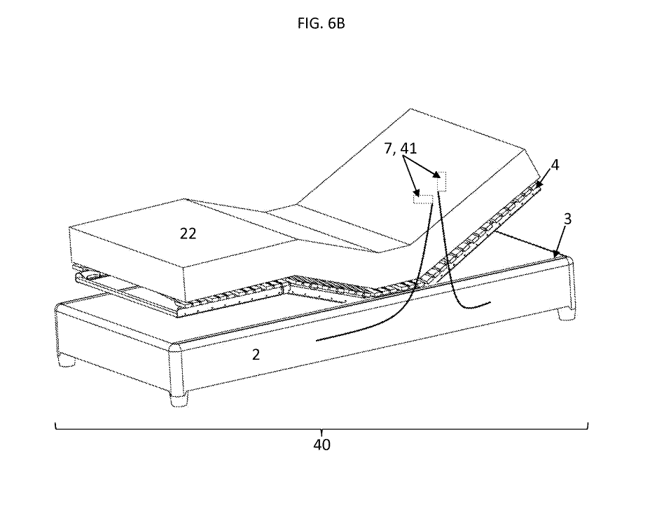

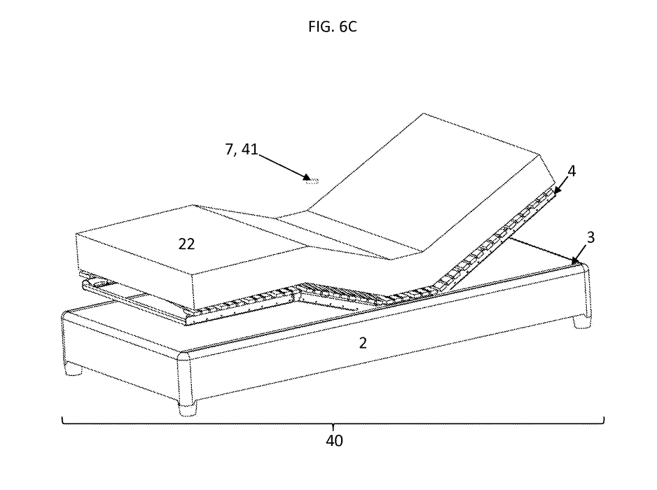

### DETAILED DESCRIPTION OF THE INVENTION

An adjustable bedframe 1 that fits onto an existing bedframe structure 2 comprising a base 3, an adjustable frame 4, an upper adjustment means 5, a lower adjustment means 6, and a plurality of controllers 7. The base 3 is comprised of a left member 8, a right member 9, an upper member 10, a lower member 11, and a plurality of cross members 12 for stability and the base 3 is sized to be placed onto the existing bedframe structure 2 of a bed.

The adjustable frame 4 is comprised of a head portion 13, a center portion 14, a lower portion 15, and a foot portion 16. The center portion 14 is comprised of an upper edge 17, a lower edge 18, a left edge 19, a right edge 20, and a plurality of slats 21 extending from the left edge 19 to the right edge 20 to support a mattress 22, wherein the slats 21 are a material appropriate to support the mattress and the additional weight of the occupant or occupants of the bed. The left edge 19 of the center portion 14 is attached to the attached to the left member 8 of the base 3 by a plurality of fastening means 23, wherein said plurality of fastening means 23 is comprised from at least one of rivits, screws, bolts, or welds The right edge 20 of the center portion 14 is attached to the attached to the right member 9 of the base 3 by a plurality of fastening means 23.

The head portion 13 comprises a lower edge 24, an upper edge 25, a left edge 26, a right edge 27, and a plurality of slats 21 extending from the left edge 26 to the right edge 27 to support a mattress 22, wherein the slats 21 are a material appropriate to support the mattress and the additional weight of the occupant or occupants of the bed. The lower edge 24 of the head portion 13 is connected to the upper edge 17 of the center portion 14 by a plurality of hinges 28 such that the head portion 13 can be articulated up and down relative to the center portion 14.

The lower portion 15 comprises an upper edge 29, a lower edge 30, a left edge 31, a right edge 32, and a plurality of slats 21 extending from the left edge 31 to the right edge 32 to support a mattress 22, wherein the slats 21 are a material appropriate to support the mattress and the additional weight of the occupant or occupants of the bed. The upper edge 29 of the lower portion 15 is connected to the lower edge 18 of the center portion 14 by a plurality of hinges 28 such that the lower portion 15 can be articulated up and down relative to the center portion 14.

The foot portion 16 comprises an upper edge 33, a lower edge 34, a left edge 35, a right edge 36, and a plurality of slats 21 extending from the left edge 35 to the right edge 36 to support a mattress 22, wherein the slats 21 are a material appropriate to support the mattress and the additional weight of the occupant or occupants of the bed. The upper edge 33 of the foot portion 16 is connected to the lower edge 30 of the lower portion 15 by a plurality of hinges 28 such that the foot portion 16 can be articulated up and down relative to the lower portion 15. There are also a plurality of stability arms 37 that connect the foot portion 16 to the base 3 such that, as the lower portion 15 is raised up relative to the center portion 14 the foot portion 16 is maintained relatively parallel with the base 3 and further, as weight is placed on the foot portion 16, the plurality of stability arms 37 add structural support for the foot portion 16.

The upper adjustment means 5 is attached to the base 3 and the head portion 13 in such a fashion so that the upper adjustment means 5 facilitates to the raising and lowering of the head portion 13 relative to the center portion 14. The lower adjustment means 6 is attached to the base 3 and the lower portion 15 in such a fashion so that the lower adjustment means 6 facilitates to the raising and lowering of the lower portion 15 relative to the center portion 14.

The upper adjustment means 5 and the lower adjustment means 6 are in the form of linear actuators that may be manually operated or motorized.

The plurality of controllers 7 operates the mechanics of the upper adjustment means 5, thus controlling the raising and lowering of the head portion 13. The plurality of controllers 7 also operates the mechanics the lower adjustment means 6, thus controlling the raising and lowering of the lower portion 15. In the first embodiment 38 of the plurality of controllers 7 for the upper adjustment means 5 and the lower adjustment means 6 is a manual crank means 39 for the upper adjustment means 5 and a manual crank means 39 for the lower adjustment means 6. In the second embodiment 40 of the plurality of controllers 7 the plurality of controllers 7 for the upper adjustment means 5 and the lower adjustment means 6 is an electronic means 41, wherein there may two separate electronic means 41, one to activate the motorized mechanics of the upper adjustment means 5 and a second electronic means 41 to activate the motorized mechanics of the lower controllers 6, or a single electronic means 41 that is able one to activate the motorized mechanics of the both the upper adjustment means 5 and the lower adjustment means 6.

What is claimed:

1. An adjustable bedframe that fits onto an existing bedframe structure comprising:
A base, an adjustable frame, an upper adjustment means, a lower adjustment means and a plurality of controllers;
wherein the base is comprised of a left member, a right member, an upper member, a lower member, and a plurality of cross members for stability;
wherein the base is sized to be placed onto the existing bedframe structure;
wherein the adjustable frame is comprised of a head portion, a center portion, a lower portion, and a foot portion;
wherein the center portion is comprised of an upper edge, a lower edge, a left edge, a right edge, and a plurality of slats extending from the left edge to the right edge to support a mattress;
wherein the left edge is attached to the attached to the left member of the base by a plurality of fastening means;
wherein the right edge is attached to the attached to the right member of the base by a plurality of fastening means;
wherein the head portion comprises a lower edge, an upper edge, a left edge, a right edge, and a plurality of slats extending from the left edge to the right edge to support a mattress;
wherein the lower edge of the head portion is connected to the upper edge of the center portion by a plurality of hinges such that the head portion can be articulated up and down relative to the center portion;
wherein the lower portion comprises an upper edge, a lower edge, a left edge, a right edge, and a plurality of slats extending from the left edge to the right edge to support a mattress;
wherein the upper edge of the lower portion is connected to the lower edge of the center portion by a plurality of hinges such that the lower portion can be articulated up and down relative to the center portion;
wherein the foot portion comprises an upper edge, a lower edge, a left edge, a right edge, and a plurality of slats extending from the left edge to the right edge to support a mattress;
wherein the upper edge of the foot portion is connected to the lower edge of the lower portion by a plurality of hinges such that the foot portion can be articulated up and down relative to the lower portion;
wherein the upper adjustment means is attached to the base and the head portion in such a fashion so that the upper adjustment means facilitates to the raising and lowering of the head portion relative to the center portion;
wherein the lower adjustment means is attached to the base and the lower portion in such a fashion so that the lower adjustment means facilitates to the raising and lowering of the lower portion relative to the center portion; and
wherein there are a plurality of stability arms that connect the foot portion to the base such that, as the lower portion is raised up relative to the center portion the foot portion is maintained relatively parallel with the base and further, as weight is placed on the foot portion, the plurality of stability arms add structural support for the foot portion.

2. The plurality of controllers controls the upper adjustment means, thus controlling the raising and lowering of the head portion and the lower adjustment means, thus controlling the raising and lowering of the lower portion.

3. The adjustable bedframe of claim 2 wherein the plurality of controllers for the upper adjustment means is a manual crank means; and
wherein the plurality of controllers for the lower adjustment means is a manual crank means.

4. The adjustable bedframe of claim 2 wherein the plurality of controllers for the upper adjustment means is an electronic means;
wherein the plurality of controllers for the lower adjustment means is an electronic means.

5. The adjustable bedframe of claim 4 wherein the plurality of controllers for the upper adjustment means and the plurality of controllers for the lower adjustment means is the same controller.
